(19) United States
(12) Patent Application Publication
(10) Pub. No.: US 2007/0235303 A1
(43) Pub. Date: Oct. 11, 2007

(54) Architecture for multi-throw micro-fluidic devices

(76) Inventor: Timothy Beerling, San Francisco, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/399,644

(22) Filed: Apr. 6, 2006

(51) Int. Cl. H01H 29/00

(52) U.S. Cl. 200/182

(57) ABSTRACT

In accordance with the invention, a multiple throw switching device can be achieved on a single substrate by organizing a micro-fluidic switch into spokes radiating outward from the center of a wafer such that each spoke (switch throw) controls a switched output and each switch throw, in turn, is controlled by an individual stimulus.

### BACKGROUND

Single substrate single pole double throw micro-fluidic switching devices have been designed using liquid metal actuation to provide switching. These switches can use a single switching stage for achieving the open or closed state between two outputs. In one embodiment, high frequency signals can be switched from an input to an output by applying a stimulus, for example, pressure to the liquid within the switch body. The applied pressure (which is generated by a number of methods) causes the liquid (usually liquid metal) to move to one of two bi-stable states. Currently, when more than two throws are required, a plurality of these single stage switches must be used. A four-throw switch (having four possible outputs) would require three distinct switches, where the outputs of the switch of the first stage would become the inputs for two switches of the second stage. Separate switches, in addition to taking up valuable space on a wafer substrate, require complex circuitry to operate.

### SUMMARY

In accordance with the invention, a multiple throw switching device can be achieved on a single substrate by organizing a micro-fluidic switch into spokes radiating outward from the center of a wafer such that each spoke (switch throw) controls a switched output and each switch throw, in turn, is controlled by an individual stimulus.

### BRIEF DESCRIPTION OF THE DRAWINGS

FIG. 1 is an overhead view of one embodiment of a single pole multi-throw device in accordance with the invention;

FIGS. 2A-2D are perspective views of one embodiment illustrating the switching operation of a multi-throw device in accordance with the invention; and

FIGS. 3A-3D are simplified diagrams illustrating the switching mechanism of one embodiment of a multi-throw device in accordance with the invention.

### DETAILED DESCRIPTION

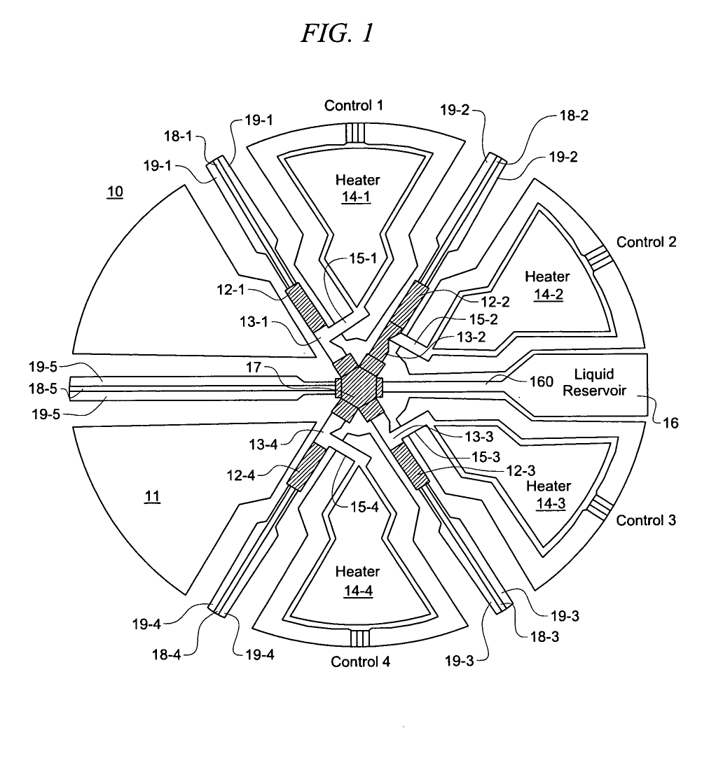

FIG. 1 is an overhead view of one embodiment 10 of a single pole multi-throw device in accordance with the invention. Device 10 is manufactured on a substrate using micromachining and thin film fabrication techniques and can be made of any suitable material using any suitable process.

Device 10 comprises four single pole single throw switches sharing a single switch pole (manifold) 17 creating a multiple throw switch. The switches are comprised of throw contacts 12-1 to 12-4, contact cavities 13-1 to 13-4, heaters 14-1 to 14-4, heated gas channels 15-1 to 15-4, liquid reservoir 16, switch pole 17, vents 18-1 to 18-5, electrical (high frequency) connections 19-1 to 19-5; The shaded areas indicate conductive liquid. The conductive liquid may be any liquid that conducts electrical signals including, but not limited to liquid metals, such as mercury, gallium alloys, and indium alloys. While the present embodiment illustrates a single pole four throw switch, alternative embodiments may use any number of throws.

It is noted that while the embodiment of FIG. 1 has switch elements placed radially about a central manifold, alternative embodiments may have an enlarged manifold allowing for switch elements to be placed parallel to each other, for example, a rectangular manifold with switch elements placed in parallel with respect to each other and perpendicular to the manifold.

Throw contacts 12-1 to 12-4, switch pole 17 are cavities formed between a flat surface of a substrate, and the etched surface of another substrate with the two substrates bonded together. The cavities store the liquid and have wetted electrically conductive surfaces attracting the liquid. Throw contacts 12-1 to 12-4 are electrically connected to connections 19-1 to 19-4, respectively, and pole 17 is electrically connected to connection 19-5. Contact cavities 13-1 to 13-4 separate pole contact 17 from throw contacts 12-1 to 12-4, respectively, and have nonwetted surfaces. These portions of the cavities are not electrically conductive, such that when a given contact cavity is empty (i.e., no metallic liquid therein) switch pole 17 is electrically isolated from the contact associated with that cavity. For example, if cavity 13-1 is empty of liquid there is electrical isolation between contact 12-1 and pole contact 17 switch pole 17 and the given contact cavity's throw contact are not electrically connected. In order to electrically connect pole 17 with a particular cavity switch of device 10, liquid must bridge the gap from pole 17 to the switch.

As illustrated in FIG. 1, contact cavities 13-1, 13-3, and 13-4 are empty and the liquid of pole 17 is separated from the liquid of throw contacts 12-1, 12-3, and 12-4, such that pole 17 is not electrically connected to throw contacts 12-1, 12-3, and 12-4. However, contact cavity 13-2 is full, and thus, the liquid of pole 17 is continuous with the liquid of throw contact 12-2, such that pole 17 is electrically connected to throw contact 12-2. Accordingly, input 19-5 is in electrical contact with output 19-2. It is noted that, as with conventional switches, the direction of electrical signals is not constrained by device 10, such that any of connections 19-1 to 19-5 may be configured as electrical signal inputs or outputs, depending, at least in part, upon the desired use of device 10.

Heat connecting channels 15-1 to 15-4 have nonwetted surfaces and serve to connect contact cavities 13-1 to 13-4 with heaters 14-1 to 14-4, respectively. These heaters could be, for example, joule heaters. As will be discussed, heaters 14-1 to 14-4 operate to control the movement of the liquid within device 10 to make connections between throw contacts 12-1 to 12-4 and contact 17. Heaters 14-1 to 14-4 operate by heating gases, which gases are passed through channels 15-1 to 15-4 thereby causing the liquid within the associated chamber of device 10 to move in a desired direction, as will be discussed.

Electrical connectors 19-1 to 19-5 allow other electrical devices to be connected to device 10. Vents 18-1 to 18-5 are cavities in substrate 11 serving to allow trapped gases to escape, which is particularly important during liquid loading of the switch, once microfabrication has been completed. These vents have nonwetted surfaces to repel and prevent the escape of liquid from throw contacts 12-1 to 12-4 (for vents 18-1 to 18-4) and pole 17 (for vent 18-5). Reservoir cavity 16 also has nonwetted surfaces which allow for the storage of excess amounts of liquid that may temporarily overflow from pole 17 during the operation of device 10. The reservoir is also used in the loading of liquid metal into the device.

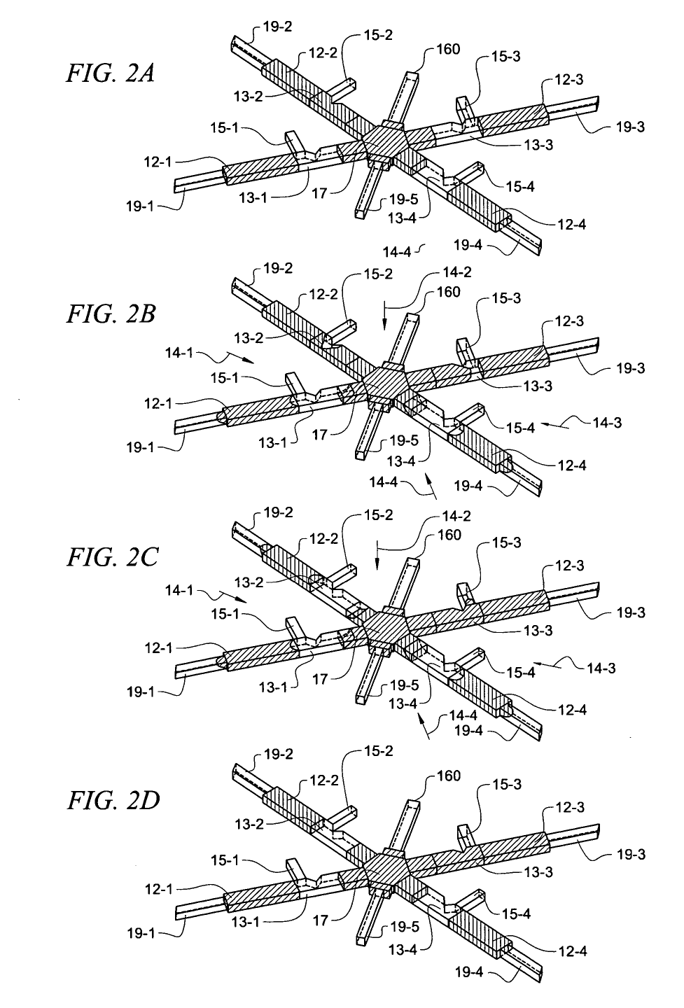

FIGS. 2A-2D are perspective views of one embodiment illustrating the switching operation of a multi-throw device in accordance with the invention. As illustrated in FIG. 2A, contact cavity 13-2 is the only contact cavity that is full of liquid (as shown by the diagonal lines). (Note that cavities 13-1, 13-3, and 13-4 are empty of liquid.) The fact that contact cavity 13-2 is full of liquid means that electrical continuity exists between connector 19-2, through cavities 12-2 and 13-2 to contact 17. Contact cavities 13-1, 13-3, and 13-4 are empty such that electrical continuity does not exist between connectors 19-1, 19-3, and 19-4 and contact 17. Since connector 19-5 is electrically connected to contact 17, then if follows that electrical continuity exists between connectors 19-5 and 19-2.

Note that reservoir cavity 16 is also empty, at this time.

Assume now that it is desired to change the switch so post-electrical continuity exists between connectors 19-5 and 19-3. Referring to FIG. 2B, heaters 14-1, 14-2, and 14-4 (shown in FIG. 1 and represented in FIGS. 2A-2D with arrows) are turned on and heater 14-3 (represented by a light arrow) remains in its state. Heater 14-2 being turned on causes the liquid in contact chamber 13-2 to move out of that chamber and into contact 17 chamber. Heaters 14-1 and 14-4 being on keep the liquid from flowing into contact cavities 13-1 and 13-4. The combination of pressures from heaters 14-1, 14-2, and 14-4 operate to cause liquid from chamber 17 to flow into both channel 160 and into contact cavity 13-3. This follows since cavity 13-3 is at a lower pressure than the other cavities since heat is not being applied by heater 14-3 to cavity 13-3.

Referring to FIG. 2C, heaters 14-1, 14-2, and 14-4 have been on long enough to break the connection between pole contact 17 and formally closed throw contact 12-2 by emptying contact cavity 13-2. Since liquid has now moved into cavity 13-3, there is electrical continuity between connectors 19-5 and 19-3 and no electrical contact between connectors 19-5 and 19-2. Note that the excess amounts of liquid that cannot be held by pole 17 is pushed primarily into channel 160 which acts as a temporary overflow buffer for liquid flowing within the device. Also note that a small amount of liquid is pushed into heat connecting channel 15-3, which can also act as an overflow buffer.

Referring to FIG. 2D, heaters 14-1, 14-2, and 14-4 have been turned off, and the excess liquid that was in reservoir cavity 16 and heat cavity 15-2 has settled back into pole cavity 17. Contact cavity 13-2 has been emptied and contact cavity 13-3 has been filled, thus changing the electrical connection that existed between terminals 19-5 and 19-2 to a new connection between 19-5 and 19-3.

A controlling factor in how many poles can be closed at any one time is that the switch must have enough liquid to fill all the cavities that are to be “closed.” However, if too much liquid is added, then the liquid would have no place to go and some switch throws would remain closed even when heat (pressure) is applied. Reservoir 16 is primarily used during loading, where it is filled and then expelled into the various channels. However, during switching come liquid metal could temporarily move into the reservoir. In most situations, the liquid moving between channels during switching would most likely only make it as far as the connection between the switch and the reservoir. Alternative embodiments may make electrical connections with more than one throw contact. For example, if in the previous discussion with respect to FIGS. 2B and 2C, heater 14-4 had been left off, both contact cavities 13-3 and 13-4 would have been filled, thereby electrically connecting connector 19-5 with both connectors 19-3 and 19-4 in situations where a proper amount of liquid has been loaded into the device.

Further, alternative embodiments may have switch throws for each electrical connection. For example, if electrical connection 19-5 were to be removed, or not used, any one or more terminals 19-1 to 19-4 could be selectively connected to any one or more other terminals 19-1 to 19-4.

Alternative embodiments may have the contact cavities of multiple poles connected to a single heater, thus creating a multi-pole switch.

It is noted that while gas pressure is used to move the liquid within device 10, alternative embodiments may use any other suitable means to move the liquid, such as electrowetting on dielectric or micro-electro-mechanical pumps and motors and combinations of the above.

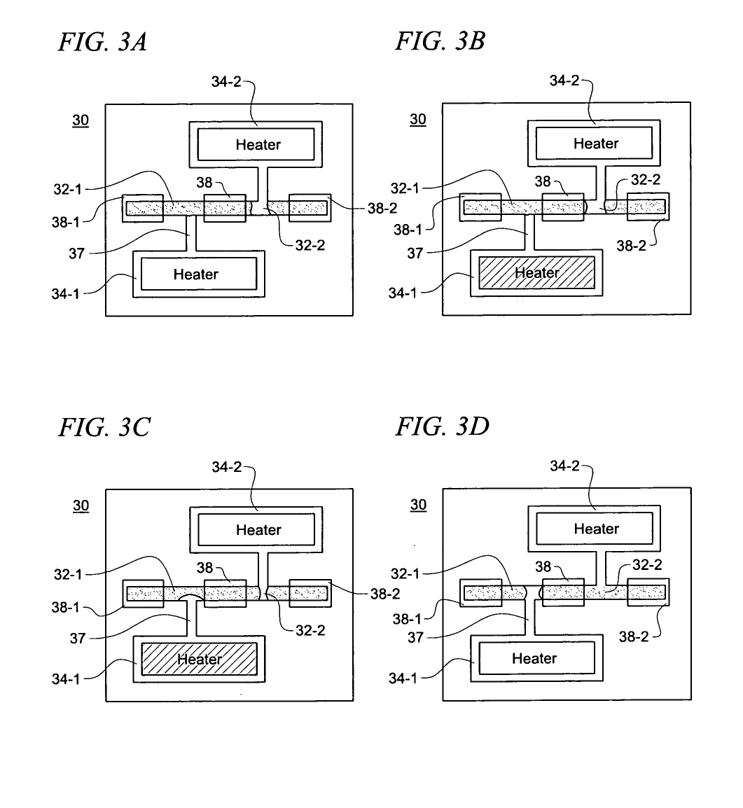

FIGS. 3A-3D are simplified diagrams illustrating the switching mechanism of one embodiment 30 of a multi-throw device having a single pole and two throws in accordance with the invention. Referring to FIG. 3A, both heaters 34-1 and 34-2 are off. The left side of switch 30 (between element 38 and element 38-1) is closed (containing liquid), and the right side (between element 38 and element 38-2) is open (no liquid). To open the left side of switch 30 and close the right side, heater 34-1 is turned on as shown in FIG. 3B. Heater 34-1 increases the gas pressure on the liquid in cavity 32-1 via cavity 37, thereby causing the liquid in left side cavity 32-1 to begin to move into right side cavity 32-2 as shown beginning to happen in FIG. 3C.

As shown in FIG. 3D, after enough liquid has been pushed from cavity 32-1 into cavity 32-2, the left side opens between element 38-1 and element 38, and the right side closes between element 38 and element 38-2. Heater 34-1 is then turned off.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A switching device comprising:
a first connector;
a plurality of other electrical connectors switchably connected to said first connector;
a plurality of switches spaced apart on a die, each said switch having a shared input and an output, said output electrically connected to an individual ones of said other electrical connectors, said switches adapted such that switch controllable material can flow between said input and said output; and
a plurality of switch control elements interposed on said die adjacent each switch, each said control element associated with a particular one of said switches, each said switch control element operable for controlling said switch controllable material within an associated switch.

2. The device of claim 1 wherein said shared input is at the center of a radius with the output of each said switch spaced apart around an arc.

3. The device of claim 1 wherein said switch control elements are operable for directing signals received on said input to at least one selected output.

4. The device of claim 1 wherein said received signals are high frequency signals.

5. The device of claim 1 wherein said control elements are individually controllable heaters.

6. The device of claim 5 wherein said switch controllable material is liquid metal.

7. The device of claim 6 wherein said switch control elements are individually controllable heaters operable for increasing the pressure within a switch to cause said liquid to at least partially flow away from said switch.

8. The device of claim 7 further comprising:
a liquid reservoir on said die, said liquid reservoir connected to said input of said switches and operable for buffering liquid metal within said switches.

9. The method of operating a micro-fluidic switch, said method comprising:
raising the pressure within at least one of a number of switch elements in a matrix of switch elements; and
allowing liquid within said switch elements to which pressure has been raised to flow to other switch elements within said micro-fluidic switch where the internal pressure of said other switch elements is lower.

10. The method of claim 9 wherein said pressure raising is controlled by heaters associated with each said switch element.

11. The method of claim 10 wherein said switch elements and said heaters are arranged in an arc on a die.

12. A switching device comprising:
a die having created thereon fluidic switches spaced around a liquid manifold common to said switches; and
means created within said die and interspersed with said switches for selectively controlling liquid flow among said switches such that said liquid flow controls the passage of signals from said common liquid manifold to an output of selected ones of said switches.

13. The device of claim 12 wherein said selective control means comprises:
means for changing the pressure within selected ones of said switches.

14. The device of claim 13 wherein said pressure changing means comprises joule-heating elements.

15. The device of claim 14 wherein said pressure adjusting means further comprises vents formed within said die.

16. The device of claim 12 wherein said signals are selected from the list of: current, voltage, and RF.

17. The device of claim 12 wherein the number of said switches is greater than two.

18. The device of claim 17 wherein said selective controlling means is shaped to fit between said switches.

19. A micro-fluidic multiple throw switch constructed on a die comprising:
a manifold constructed in a center region of said die, said manifold allowing the passage of liquid there-through;
a plurality of channels radiating in an arc outward from said manifold, each said channel operable for allowing liquid from said manifold to move along said channel, said liquid selectively movable for facilitating the passage of an electrical signal along said channel in which said liquid is located;
pressure creating elements dispersed between said channels, each said element associated with one of said channels and each said element selectively controllable;
at least one liquid reservoir formed in said die for buffering the flow of liquid to and from said manifold; and
at least one input connected to said manifold for supplying an electrical signal to said manifold.

20. The device of claim 19 wherein said pressure creating elements are heaters constructed on said die.
